(19) United States
(12) Patent Application Publication
(10) Pub. No.: US 2022/0290001 A1
(43) Pub. Date: Sep. 15, 2022

(54) SELF-EMULSIFYING EPOXY COMPOSITION AND THE COATING COMPOSITION PREPARED FROM THE SAME

(71) Applicant: RHODIA OPERATIONS, Aubervilliers (FR)

(72) Inventors: Peng ZHANG, Singapore (SG); Weijing LV, Shanghai (CN); Yanhui CHEN, Shanghai (CN); Peng XU, Singapore (SG)

(21) Appl. No.: 17/637,514

(22) PCT Filed: Sep. 4, 2019
(86) PCT No.: PCT/CN2019/104363

§ 371 Date: Feb. 23, 2022

(51) Int. Cl. C09D 163/04

(52) U.S. Cl. CPC C09D 163/04

(57) ABSTRACT

A self-emulsifying epoxy composition is prepared by the components comprising an epoxide adduct a) and an epoxide compound b), the solid content of the self-emulsifying composition has a smaller particle size. The self-emulsifying epoxy composition can be used to prepare the coating composition which has favorable anti-corrosion-performance.

### TECHNICAL FIELD

The present invention relates to a self-emulsifying epoxy composition prepared by the components comprising an epoxide adduct a), an epoxide compound b) and catalyst, the solid content of the self-emulsifying composition has a smaller particle size. The present invention also relates to the coating composition prepared by the same which has favorable anti-corrosion performance.

### BACKGROUND

Epoxy resin is widely used in various fields such as coatings, adhesives and composite materials because of its favorable performance, such as strong adhesion, excellent mechanical properties, outstanding environmental degradation resistance, good thermal stability, acid and alkali resistance and the like. Although epoxy coatings have excellent physical and chemical properties, the traditional epoxy resin coatings are based on organic solvents which are detrimental to environment and people's health. In contrast, waterborne epoxy resins are gaining more and more attention because of their environmentally and healthy advantages.

The preparation of the conventional water-borne epoxy resin is mainly divided into two types: external emulsification method and self-emulsification method. In the external emulsification method, a surfactant is added to the formulation to emulsify the epoxy resin under high shear so as to obtain an aqueous epoxy resin emulsion. The product prepared by the method has large particle size, poor storage stability and water resistance.

In the self-emulsification method, a hydrophilic group or a segment is introduce to an epoxy resin molecule by chemical modification, thereby increasing the hydrophilic-lipophilic balance (HLB) value so that it can freely dispersed in water.

U.S. Pat. No. 5,459,180 discloses a polyol/epoxy adducts which can be used as an emulsifier for epoxy resins, and the polyol/epoxy adducts are on aromatic based, such as BADGE (diglycidyl ether of bisphenol A) or BFDGE (diglycidyl ether of bisphenol F).

U.S. Pat. No. 5,925,725 discloses an emulsifier composition and a dilutable epoxy resin based on the same, wherein the emulsifier composition is a condensation product of an aliphatic polyol and an aromatic epoxide compound.

It would also be desirable to develop new self-emulsifying epoxy resin.

### SUMMARY OF THE INVENTION

In one aspect of the present invention is provided a self-emulsifying epoxy composition, which is prepared from aliphatic based epoxide adduct. Compared to those in the art, the self-emulsifying epoxy composition of the present invention has smaller particle size (D₅₀ or D₉₀), thus can provide favorable properties to the composition.

The self-emulsifying epoxy composition is prepared by the components comprising:
a) an epoxide adduct, wherein the epoxide adduct has a formula of I or II

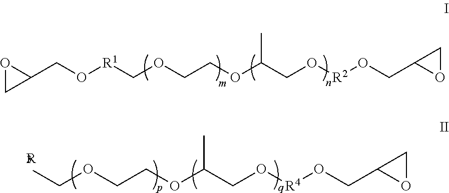

wherein R¹ and R² are independently selected from C₁-C₃₀ aliphatic hydrocarbonyl groups or C₃-C₃₀ cycloaliphatic hydrocarbonyl groups, m is an integer selected from 20 to 200, n is 0 or an integer selected from 1 to 100;
R³ and R⁴ are independently selected from C₁-C₃₀ aliphatic hydrocarbonyl groups or C₃-C₃₀ cycloaliphatic hydrocarbonyl groups, p is an integer selected from 20 to 200, q is 0 or an integer selected from 1 to 100;
b) an epoxide compound, wherein the epoxide compound has at least two epoxide groups per molecule and an epoxide group content of 500 to 10,000 mmol/kg, and an amount of 25-90 wt. %, based on 100% by weight of the self-emulsifying epoxy composition; and
c) catalysts.

In one embodiment of the present invention, the epoxide adduct has a weight average molecular weight of 1,000 to 20,0000.

In another embodiment of the present invention, the epoxide adduct has an amount of 1-20 wt. %, based on 100% by weight of the self-emulsifying epoxy composition.

In yet another embodiment of the present invention, the epoxide adduct has an epoxidize ratio of 50-100%.

In still yet another embodiment of the present invention, R¹, R², R³ and R⁴ are independently selected from C₁-C₁₀ aliphatic hydrocarbonyl groups and C₃-C₁₀ cycloaliphatic hydrocarbonyl groups.

In still yet another embodiment of the present invention, the epoxide compound b) has a formula of III or IV

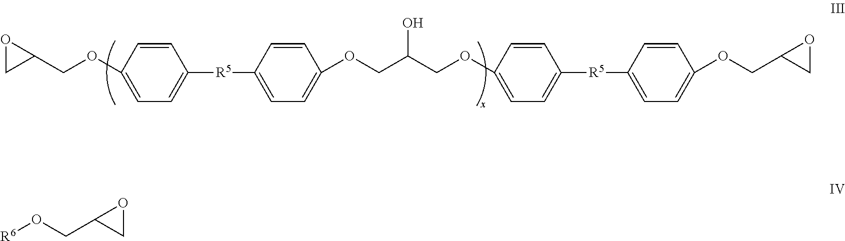

wherein x is 0 or an integer of 1 to 10, R⁵ is selected from aliphatic C₁-C₃₀ aliphatic hydrocarbonyl groups or C₃-C₃₀ cycloaliphatic hydrocarbonyl groups, R⁶ is selected from aliphatic, cycloaliphatic or aromatic hydrocarbonyl groups having 3-20 carbon atoms.

In still yet another embodiment of the present invention, R⁵ is selected from C₁-C₁₀ aliphatic hydrocarbonyl groups.

In still yet another embodiment of the present invention, R⁶ is selected from C₃-C₂₀ aliphatic hydrocarbonyl groups atoms or aromatic hydrocarbonyl group having 3-12 carbon atoms.

In still yet another embodiment of the present invention, the composition further comprises a bisphenol compound with an amount of 1-25 wt. %, based on 100% by weight of the self-emulsifying epoxy composition.

In still yet another embodiment of the present invention, the bisphenol compound is selected from Bisphenol A, Bisphenol F or the combination thereof.

In still yet another embodiment of the present invention, the solid in the self-emulsifying epoxy composition has a particle size diameter range with a D₉₀ from 0.3 μm to 3 μm, as determined by means of laser light diffraction.

In another aspect of the present invention is provided the use of the self-emulsifying epoxy composition in coating, adhesive, sealant, and paints.

In another aspect of the present invention is provided a coating composition comprising
a) an coating component comprising the self-emulsifying epoxy composition;
b) an epoxy curing agent; and
c) optional solvents and additives.

In one embodiment of the present invention, the coating component has an amount of 40-70 wt. %, based on 100% by weight of the coating composition.

In another embodiment of the present invention, the coating composition is a container coating, machinery coating, marine coating, or wind power coating.

### BRIEF DESCRIPTION OF THE DRAWINGS

FIG. 1 shows a cold rolled steel plate subjected to neutral spray test, the width of the extension corrosion at scratch line is lower than 2 mm.

### DETAILED DESCRIPTION OF THE INVENTION

This disclosure will be described more fully in the following detailed description of the invention, and with reference to the accompanying drawings, in which some but not all embodiments of the disclosure are described. This disclosure may, however, be embodied in many different forms and is not to be construed as limited to the exemplary embodiments set forth herein; rather, these embodiments are provided so that this disclosure will be thorough and complete, and will fully convey the scope of the invention to those skilled in the art. Like reference numerals and variables refer to like elements throughout.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements and/or components, but do not preclude the presence or addition of one or more other features, regions, integers, steps, operations, elements, components and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “aliphatic hydrocarbonyl” refers to a hydrocarbonyl group containing carbon and hydrogen joined together in straight chains, joined chains, or non-aromatic rings.

As used herein, the term “cycloaliphatic hydrocarbonyl ” refers to a hydrocarbonyl group having a valence of at least one comprising an array of atoms which is cyclic but which is not aromatic optionally substituted with lower hydrocarbonyl group.

In the present invention, the weight-average molecular weight is determined by gel permeation chromatography based on a polystyrene standard. The OH number has the same number of hydroxyl groups as 1 g of the solid resin based on this mass of the solid resin, and is determined in accordance with DIN 53240-2.

### The Epoxide Adduct

As used herein, the term “epoxide adduct” used in the present invention refers to the polymer having a polyether segment and at least one epoxide group at the end of the polymer chain.

The epoxide adduct can be used in the present invention has a formula of I or II

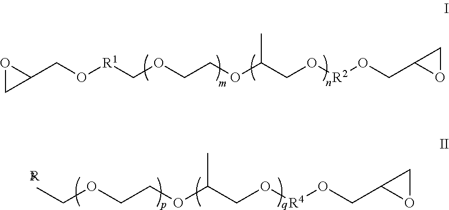

wherein R¹ and R² are independently selected from C₁-C₃₀ aliphatic hydrocarbonyl groups or C₃-C₃₀ cycloaliphatic hydrocarbonyl groups, m is an integer selected from 20 to 200, n is 0 or an integer selected from 1 to 100;
R³ and R⁴ are independently selected from C₁-C₃₀ aliphatic hydrocarbonyl groups or C₃-C₃₀ cycloaliphatic hydrocarbonyl groups m is an integer selected from 20 to 200, n is 0 or an integer selected from 1 to 100;

In one embodiment of the present invention, R¹ and R² are independently selected from C₁-C₁₀ aliphatic hydrocarbonyl groups or C₃-C₁₀ cycloaliphatic hydrocarbonyl groups, m is an integer selected from 30 to 150, n is 0 or an integer selected from 1 to 40.

In another embodiment of the present invention, R³ and R⁴ are independently selected from C₁-C₁₀ aliphatic hydrocarbonyl groups or C₃-C₁₀ cycloaliphatic hydrocarbonyl groups, p is an integer selected from 30 to 150, q is 0 or an integer selected from 1 to 40.

In the formula I or II, the ethylene oxide unit and propylene oxide unit in the polymer chain can be distributed randomly, by block or gradient.

In the present invention, the epoxide adduct is prepared by the condensation of aliphatic polyols and epoxides. The aliphatic polyols are preferably polyether polyols (polyoxyalkylene glycols) having a weight-average molecular weight of 200 to 20,000 g/mol, preferably 1000 to 10,000 g/mol, and OH numbers of expediently from 5 to 600 mg/g, preferably from 10 to 100 mg/g.

Examples of the aliphatic polyols which may be mentioned here are block copolymers of ethylene oxide and propylene oxide having hydroxyl end groups, and polyethylene, polypropylene and polybutylene glycols. The use of mixtures of the respective polyalkylene glycols is also possible. Polyethylene glycols are preferably used.

In one embodiment of the present invention, the aliphatic polyol used in the present invention is polyethylene glycols having a weight-average molecular weight of 1,000-10,000, and OH number of 10-100.

In the present invention, the epoxide is selected from ethylene oxide, propylene oxide, epichlorohydrin and the combination thereof.

The epoxide adduct used in the present invention has a weight average molecular weight of 1,000 to 20,0000, preferably 2,000 to 15,000, more preferably 2,500 to 8,000.

The epoxide adduct used in the present invention has an amount of 1-20 wt. %, preferably 1-10 wt. %, based on 100% by weight of the self-emulsifying epoxy composition.

The epoxide adduct used in the present invention can be commercial available, such as, but not limited to, poly(ethylene glycol) diglycidyl ether with various weight average molecular weight, such as 2,000, 4,000 and the like.

The epoxide adduct used in the present invention has an epoxidize ratio of 50-100%, preferably 60-100%. The epoxidize ratio is determined by the integral result of NMR, and reported by the average molar ratio between the epoxy group per molecule to the hydroxyl per raw material aliphatic polyol.

The epoxide adduct used in the present invention has an epoxide equivalent weight of 50-10000 mmol/kg, preferably 100-5000 mmol/kg, which is reported as grams of resin per epoxide group, and determined by titration according to GB/T 4612.

Without wishing to be bound to any particular theory, it is believed that the epoxide adduct act as the hydrophilic group of emulsifier in the condensation product of the epoxide adduct and the epoxide compound.

### The Epoxide Compound

The epoxide compound used in the present invention has at least two epoxide groups per molecule and an epoxide group content of 500 to 10,000 mmol/kg, which is reported as grams of resin per epoxide group, and determined by titration according to GB/T 4612.

In one embodiment of the present invention, the epoxide compound b) has an amount of 25-90 wt. %, preferably 50-90%, based on 100% by weight of the self-emulsifying epoxy composition.

The epoxide compounds used in the present invention preferably have a specific epoxide group content of from 250 to 10,000 mmol/kg, in particular from 1000 to 6700 mmol/kg (epoxide equivalent weight of from 100 to 4000, in particular from 150 to 1000 g/mol). These polyepoxides are compounds having on average at least two epoxide groups per molecule. These epoxide compounds can be either saturated or unsaturated and can be aliphatic, cycloaliphatic, aromatic and/or heterocyclic and can also have hydroxyl groups. They may additionally comprise those substituents and/or functional groups which under the conditions of mixing or reaction do not give rise to any disruptive side reactions, examples being alkyl or aryl substituents, ether groups and the like.

These epoxide compounds are preferably polyglycidyl ethers based on polyhydric, preferably dihydric, alcohols, phenols, hydrogenation products of these phenols and/or on novolaks (reaction products of mono- or polyhydric phenols with aldehydes, especially formaldehyde, in the presence of acidic catalysts).

Examples of polyhydric phenols which can be mentioned are resorcinol, hydroquinone, 2,2-bis(4-hydroxyphenyl)propane (bisphenol A), isomer mixtures of dihydroxydiphenylmethane (bisphenol F), tetrabromobisphenol A, 4,4′-dihydroxydiphenylcyclohexane, 2,2-bis(4-hydroxy-3-methylphenyl)propane, 4,4′-dihydroxybiphenyl, 4,4′-dihydroxybenzophenone, 1,1-bis(4-hydroxyphenyl)ethane, 2,2-bis[4-(2′-hydroxypropoxy)phenyl]propane, 1,1-bis(4-hydroxyphenyl)isobutane, 2,2-bis(4-hydroxy-3-tert-butylphenyl)propane, bis(2-hydroxynaphthyl)methane, 1,5-dihydroxynaphthalene, tris(4-hydroxyphenyl)methane, bis(4-hydroxyphenyl) ether, bis(4-hydroxyphenyl) sulfone, etc., and also the halogenation and hydrogenation products of the abovementioned compounds. Bisphenol A is particularly preferred in the present invention.

Examples of polyhydric alcohols as a basis for the corresponding polyglycidyl ethers are ethylene glycol, diethylene glycol, triethylene glycol, polyethylene glycols (n=4 to 35), 1,2-propylene glycol, polypropylene glycols (n=2 to 15), 1,3-propylene glycol, 1,4-butanediol, 1,5-pentanediol, 1,6-hexanediol, 1,2,6-hexanetriol, glycerol, neopentylglycol, trimethylolethane and trimethylolpropane. Polypropylene glycols (n=8 to 10) are particularly preferred in this context.

It is also possible to use polyglycidyl esters of polycarboxylic acids, which are obtained by reacting epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-naphthalenedicarboxylic acid and dimerized linolenic acid. Examples are diglycidyl adipate, diglycidyl phthalate and diglycidyl hexahydrophthalate.

A detailed listing of appropriate epoxide compounds can be found in the handbook “Epoxidverbindungen and Epoxidharze” [Epoxide Compounds and Epoxy Resins] by A. M. Paquin, Springer Verlag, Berlin 1958, Chapter IV and in Lee, Neville, “Handbook of Epoxy Resins”, McGraw-Hill Book Co., 1967, Chapter 2. The above mentioned epoxide compounds can be employed individually or in a mixture.

In one embodiment of the present invention, the epoxy compound has a formula of III or IV

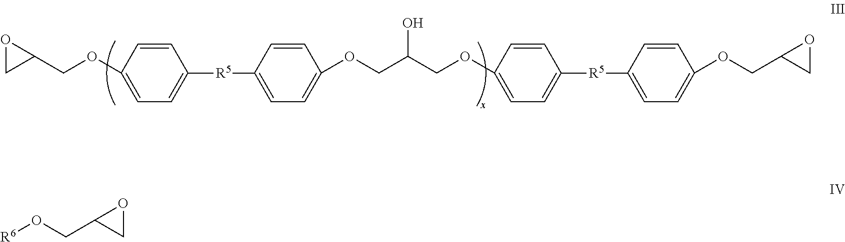

wherein R⁵ is selected from C₁-C₃₀ aliphatic hydrocarbonyl group or C₃-C₃₀ cycloaliphatic hydrocarbonyl group, x is 0 or an integer of 1 to 10, preferably R⁵ is selected from C₁-C₁₀ aliphatic hydrocarbonyl group; R⁶ is selected from C₃-C₂₀ aliphatic, cycloaliphatic or aromatic hydrocarbonyl group, preferably C₃-C₂₀ aliphatic hydrocarbon group or C₃-C₁₂ aromatic hydrocarbonyl group.

The epoxide compound used in the present invention can be commercial available, such as, but not limited to, NPEL-128 and NPES-901 commercial available from Nanya Plastic Corporation.

### Catalyst

Suitable catalysts which can be used in the present invention include strong inorganic and organic bases, for example sodium hydroxide, potassium hydroxide, lithium hydroxide, barium hydroxide, strontium hydroxide, alkali metal alcoholates such as sodium methylate, lithium methylate, sodium ethylate and potassium dodecylate, and the alkali metal salts of carboxylic acids, for example sodium stearate and lithium stearate. Also suitable are strong inorganic and organic protonic acids, for example phosphoric acid, tetrafluoroboric acid and benzenesulfonic acid. Lewis acids also can be used as catalysts. Examples include tin(IV) chloride, titanium(IV) chloride, titanium(IV) isopropylate, triethyloxonium tetrafluoroborate, and also boron trifluoride and its complexes, for example with phosphoric acid, acetic acid (1:1 and 1:2), methanol, diethyl ether, tetrahydrofuran, phenol, ethylene glycol monoethyl ether, polyethylene glycol (MW 200), dimethyl sulfoxide, di-n-butyl ether, di-n-hexyl ether, succinic acid and aliphatic, cycloaliphatic and araliphatic amines, and also nitrogen heterocycles.

As catalysts, it is preferred to employ BF₃-diethyl ether, BF₃-amine complexes, aqueous tetrafluoroboric acid and triphenylphosphine. The proportion by mass of catalyst is in general from 0 to 5 wt. %, preferably from 0.2 to 2 wt. %, based on 100 wt. % by weight of the self-emulsifying composition. To facilitate its addition, the catalyst may be diluted in a solvent such as diethyl ether, a glycol ether or cyclic ether, ketones and the like.

### Bisphenol compounds

The self-emulsifying epoxy composition of the present invention can further comprise a bisphenol compound.

Examples of bisphenol compounds which can be mentioned are resorcinol, hydroquinone, 2,2-bis(4-hydroxyphenyl)propane (bisphenol A), isomer mixtures of dihydroxydiphenylmethane (bisphenol F), tetrabromobisphenol A, 4,4′-dihydroxydiphenylcyclohexane, 2,2-bis(4-hydroxy-3-methylphenyl)propane, 4,4′-dihydroxybiphenyl, 4,4′-dihydroxybenzophenone, 1,1-bis(4-hydroxyphenyl)ethane, 2,2-bis[4-(2′-hydroxypropoxy)phenyl]propane, 1,1-bis(4-hydroxyphenyl)isobutane, 2,2-bis(4-hydroxy-3-tert-butylphenyl)propane, bis(2-hydroxynaphthyl)methane, 1,5-dihydroxynaphthalene, tris(4-hydroxyphenyl)methane, bis(4-hydroxyphenyl) ether, bis(4-hydroxyphenyl) sulfone, etc., and also the halogenation and hydrogenation products of the abovementioned compounds. Bisphenol A and F are particularly preferred bisphenol compounds in the present invention.

The bisphenol compounds used in the present invention has an amount of 0-25 wt. %, preferably 8-20 wt. %, based on 100% by weight of the self-emulsifying epoxy composition.

### Solvents

Suitable solvents can be added, if desired, to the composition. Particularly suitable solvents are organic solvents, such as glycols, mono- and di-ethers and -esters of glycols with alcohols and acids, aliphatic alcohols having linear or branched alkyl radicals of 1 to 12 carbon atoms, cycloaliphatic and araliphatic alcohols and also esters and ketones, it being possible to employ these solvents individually or in a mixture. Examples of suitable solvents include: ethylene glycol, ethylene glycol monomethyl ether, ethylene glycol dimethyl ether, butylglycol, methoxypropanol, ethoxypropanol, ethanol, 1- and 2-propanol, butanol, cyclohexanol, benzyl alcohol, ethyl acetate, acetone and methyl isobutyl ketone, although aromatic compounds such as toluene or xylene also can be used. Preferred solvents include butylglycol, methoxypropanol, methoxybutanol, isopropoxypropanol, ethoxypropanol, dipropylene glycol dimethyl ether, 2-propanol and benzyl alcohol.

### The Self-Emulsifying Epoxy Composition

Throughout this description, the expression “self-emulsifying” insofar as it refers to the epoxy composition denotes an epoxy resin wherein the emulsifier is already present during resin synthesis and is incorporated to a certain degree into the resin by the slow-reacting secondary OH groups.

In one embodiment of the present invention, the self-emulsifying epoxy composition is in a form of aqueous emulsion, particularly an oil-in-water emulsion.

The self-emulsifying epoxy composition is prepared by condensation of the composition comprising the epoxide adduct a), the epoxide compound b) and the catalyst c) (and optional bisphenol compound) at a temperature of 50 to 200° C., preferably at from 90 to 170° C., the weight ratio of the epoxide adduct a) to the epoxide compound b) being from 1:30 to 1:2.

The self-emulsifying epoxy composition has a solid content of 40-70%.

The self-emulsifying epoxy composition has a viscosity of 400 to 20,000 cps, determined by means of a Brookfield Viscometer at 25° C.

The self-emulsifying epoxy composition has a particle size diameter range with a D₉₀ from 0.3 to 3 μm, as determined by means of laser light diffraction.

The self-emulsifying epoxy composition has a particle size diameter range with a D₅₀ from 0.1 to 2 μm, as determined by means of laser light diffraction.

The D₅₀ is the diameter determined by laser scattering particle analysis at which 50% of a sample's mass is comprised of smaller particles. The D₉₀ is the diameter determined by laser scattering particle analysis at which 90% of a sample's mass is comprised of smaller particles.

The self-emulsifying epoxy composition has a fineness lower than 100 μm, as determined by Hegman gages to indicate the fineness of grind or the presence of coarse particles or agglomerates in a dispersion.

The self-emulsifying epoxy composition of the present invention can be used in various application, such as but not limited to coatings, such as protective coating, architectural coating, wood coating, adhesives, sealants, paints and the like.

### Coating

In another aspect of the present invention is provide a coating composition, which comprises
a) an coating component comprising the epoxy emulsion composition as illustrated above;
b) a curing agent; and
c) optional solvents and additives.

In one embodiment of the present invention, the coating component has an amount of 40 to 70 wt. %, based on 100% by weight of the coating composition.

### The Curing Agent

Examples of the curing agents, preferably for curing at room temperature and/or lower temperatures (amine cold hardeners), are polyalkyleneamines such as diethylenetriamine, triethylenetetramine, tetraethylenepentamine, pentaethylenehexamine, and also 2,2,4- and/or 2,4,4-trimethylhexamethylenediamine, bis(3-aminopropyl)amine, 1,4-bis(3-aminopropyl)piperazine, N,N-bis(3-aminopropyl)ethylenediamine, neopentanediamine, 2-methyl-1,5-pentanediamine, 1,3-diaminopentane, hexamethylenediamine, and also cycloaliphatic amines such as 1,2- and 1,3-diaminocyclohexane, 1,4-diamino-3,6-diethylcyclohexane, 1,2-diamino-4-ethylcyclohexane, 1-cyclohexyl-3,4-diaminocyclohexane, isophoronediamine and reaction products thereof, 4,4′-diaminodicyclohexyl-methane and -propane, bis(4-aminocyclohexyl)-methane and -propane, 3,3′-dimethyl-4,4′-diaminodicyclohexylmethane, 3-amino-1-cyclohexylaminopropane, 1,3- and 1,4-bis(aminomethyl)cyclohexane. Araliphatic amines employed are in particular those including aliphatic amino groups, for example, meta- and para-xylylenediamine or hydrogenation products thereof. The abovementioned amines can be used alone or as mixtures.

Preferred amine hardeners in addition to the above-mentioned polyamines are water-soluble polyoxyalkylene di- and poly-amines with a molar mass of from 100 to 2000 g/mol, for example, the products marketed by Texaco under the trade name Jeffamine and the readily water-dispersible curing agents as described in DE-B 23 32 177 and EP-B 0 000 605, i.e., modified amine adducts, for example.

Other hardeners which can be employed are Mannich bases, epoxy-amine adducts or polyamidoamines.

Suitable Mannich bases are prepared by condensation of polyamines, preferably diethylenetriamine, triethylenetetramine, isophoronediamine, 2,2,4- and 2,4,4-trimethylhexamethylenediamine, 1,3- and 1,4-bis(aminomethyl)cyclohexane, especially meta- and paraxylylenediamine, with aldehydes, preferably formaldehyde, and mono- or polyhydric phenols having at least one ring position which is reactive toward aldehydes, examples being the various cresols and xylenols, para-tert-butylphenol, resorcinol, 4,4′-dihydroxydiphenylmethane, 2,2-bis(4-hydroxyphenyl)propane, but preferably phenol.

Examples of suitable amine-epoxy adducts are reaction products of polyamines, for example ethylenediamine, propylenediamine, hexamethylenediamine, 2,2,4- and 2,4,4-trimethylhexamethylenediamine, meta-xylylenediamine and/or bis(aminomethyl)cyclohexane with terminal mono- or polyepoxides, such as propylene oxide, hexene oxide or cyclohexene oxide, for example, or with glycidyl ethers such as phenyl glycidyl ether, tert-butyl glycidyl ether, ethylhexyl glycidyl ether, butyl glycidyl ether or with glycidyl esters, such as the glycidyl ester of versatic acid marketed by Shell (Cardura E) or the polyglycidyl ethers and polyglycidyl esters mentioned under (B).

Polyamidoamines which can be used to cure the novel epoxy resin dispersions are obtained, for example, by reacting polyamines with mono- or polycarboxylic acids, for example, dimerized fatty acids.

In order to achieve more rapid and/or more complete through-curing, the coatings obtainable from the novel epoxy resin dispersions with the abovementioned amine hardeners can also be heated at from 50 to 120° C. for from 15 to 120 minutes.

The coating composition of the present invention has good anti-corrosion performance, thus can be used in various applications, such as but not limited to container coating, machinery coating, marine coating, wind power coating.

### EXAMPLES

### 1. Materials

NPEL-128: epoxy resin, purchased from Nanya Plastic Corporation;

TEGO® Airex 902 W: deformer, purchased from Evonik Company;

Additol® Vxw 6208: Dispersant, purchased from Allnex Company;

DeuRheo® 202: Thickener, purchased from Elementis Company;

TEGO® Wet KL 245: Wetting agent, purchased from Evonik Company;

Cold rolled steel plate: Testing substrate, purchased from Biuged company;

Malvern Mastersizer 3000 laser scattering particle analyzer: Particle size analyzer, purchased from Malvern Company.

Brookfield RVDVII+viscometer: viscometer, purchased from Malvern Company.

Emulsifier A: an epoxide adduct prepared from PEG and polyol diglycidyl ether based epoxy adduct, Mw=3200, epoxidize ratio=90%

Emulsifier B: an epoxide adduct prepared from PEG and epichlorohydrin, Mw=4200, epoxidize ratio=90%

Emulsifier C: an epoxide adduct prepared from PEG and polyol diglycidyl ether based epoxy adduct, Mw=4200, epoxidize ratio=70%

### 2. The Self-Emulsifying Epoxy Emulsion Composition

### 2.1 The Preparation of the Self-Emulsifying Epoxy Emulsion Composition

Add 124 gram NPEL-128, 31.6 gram bisphenol A and 18 gram emulsifier B into a 500 ml 3-neck flask with condenser. The mixture was heated to 170° C. under mechanical stirring to dissolve the emulsifier B and bisphenol A. 2.4 gram boron trifluoride-diethyl etherate was then charged into the flask while stirring. The flask was then closed and deoxygenation by nitrogen bubbling. The flask was kept at 170° C. while stirring for 4 hours.

After the holding period, the temperature was decreased to 90° C., and 24 gram proprylene glycol monomethyl ether was added into the flask. Following with further temperature decreased to 40° C. The output was then transferred to a 1 L jacketed vessel, the temperature of output was kept at 40° C. with circulating water.

142 gram water was slowly dropwise into the vessel while high speed dispersal with toothed dispersion plate was applied to the mixture. After 1.5 hours feeding, kept the mixture under high speed dispersal for another 1 hour. The product in the vessel was loaded out into bottle for further characterization.

Emulsifier A (example 1), C (example 3, PEG 3000 (comparative example 1) were applied in the same process as a replacement of Emulsifier B (example 2) to make self-emulsifying epoxy emulsion.

### 2.2 The Properties of the Self-Emulsifying Epoxy Composition

The particle size of the self-emulsifying epoxy composition was determined by Mastersizer 3000 laser scattering particle analyzer. Solid content was determined by oven under 105° C. for 2 hours. The epoxide equivalent weight was reported as grams of resin per epoxide group, determined by titration, GB/T 4612 process.

Fineness was determined by Grindometers and reported in μm.

TABLE 1
the properties of the self-emulsifying epoxy compositions

| | | Value | | | |
|---|---|---|---|---|---|
| Property | Unit | Comparative example 1 | Example 1 | Example 2 | Example 3 |
| Particle size(D₅₀) | μm | 0.99 | 0.69 | 0.46 | 0.59 |
| Particle size(D₉₀) | μm | 1.78 | 1.56 | 0.85 | 1.24 |
| Weight per epoxide | g/eq | 533 | 521 | 553 | 578 |
| Solid content | % | 55.1 | 54.5 | 54.8 | 55.9 |
| Fineness | μm | 70 | 40 | 30 | 30 |
| Fineness after 1 month@50 degree | μm | >100 | 60 | 40 | 40 |
| Viscosity | cps | 1854 | 942 | 3211 | 1752 |

As shown in table 1, compared to the self-emulsifying compositions prepared by PEG 3000, the self-emulsifying compositions of the present invention has smaller particle size (D₅₀ or D₉₀) and fineness.

### 3. The Coating Composition

The coating composition is prepared as follows:

Add self-emulsifying epoxy compositions of example 2, pigment, water, deformer, dispersant and thickener as the above sheet into a 250 ml vessel. The mixture was then dispersed with a toothed dispersion plate and 1000 rpm until the fineness is lower than 10 μm.

Lower down the stirring speed to 400 rpm, charge leveling agent, wetting agent and residual water as above sheet into the vessel. Kept stir for another 30 minutes. The output was transferred into a container as component A.

Add epoxy hardener and solvent as above sheet into a 50 ml beaker. Stir the mixture with four-bladed propeller for 15 minutes. The output was transferred into a container as component B.

100 gram component A, 20 gram component B and 10 gram water was added into a container with four-bladed propeller, and well mixed under 400 rpm. The mixture was transferred into a spray gun to be applied onto polished cold rolled steel for application test.

TABLE 2
the formulation of the coating composition
Component A

| | | |
|---|---|---|
| epoxy compositions | | 69.00 |
| Pigment | Ti-Pure ™ R-706 | 20.00 |
| Water | | 6.00 |
| Deformer | TEGO ® Airex 902 W | 0.05 |
| Dispersant | Additol ® Vxw 6208 | 2.00 |
| Thickener | DeuRheo ® 202 | 0.30 |
| Levelling agent | TEGO ® Wet KL 245 | 0.20 |
| Wetting agent | TEGO ® Wet KL 245 | 0.20 |
| water | | 2.25 |
| Total | | 100.00 |

Component B

| | | |
|---|---|---|
| Epoxy hardener | EPIKURE ™ 6870-W-53 | 10.00 |
| Solvent | Proprylene glycol monomethyl ether | 5.00 |
| Solvent | Ethylene Glycol | 3.00 |
| | Monobutyl Ether | |
| water | | 2.00 |
| Total | | 20.00 |

The anti-corrosion performance is determined by neutral salt spray testing under 35 Celsius with 60um dry film thickness according to ASTM D117.

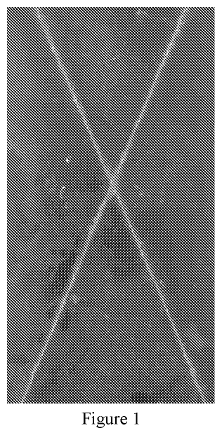

As shown in the FIG. 1, even after 500 hours salt spray test, the width of the extension corrosion at scratch line is still lower than 2 mm, which can meet C5 requirement in ISO 12944 standard.

1-15. (canceled)

16. A self-emulsifying epoxy composition, prepared by the components comprising:
a) an epoxide adduct, wherein the epoxide adduct has a formula of I or II 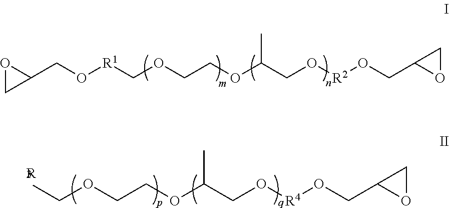
wherein R¹ and R² are independently selected from C₁-C₃₀ aliphatic hydrocarbonyl groups and C₃-C₃₀ cycloaliphatic hydrocarbonyl groups, m is an integer selected from 20 to 200, n is 0 or an integer selected from 1 to 100;
R³ and R⁴ are independently selected from C₁-C₃₀ aliphatic hydrocarbonyl groups and C₃-C₃₀ cycloaliphatic hydrocarbonyl groups, p is an integer selected from 20 to 200, q is 0 or an integer selected from 1 to 100;
b) an epoxide compound, wherein the epoxide compound has at least two epoxide groups per molecule and an epoxide group content of 500 to 10,000 mmol/kg, and an amount of 25-90 wt. %, based on 100% by weight of the self-emulsifying epoxy composition; and
c) catalysts.

17. The self-emulsifying epoxy composition according to claim 16, wherein the epoxide adduct has a weight average molecular weight of 1,000 to 20,0000.

18. The self-emulsifying epoxy composition according to claim 16, wherein the epoxide adduct has an amount of 1-20 wt. %, based on 100% by weight of the self-emulsifying epoxy composition.

19. The self-emulsifying epoxy composition according to claim 16, wherein the epoxide adduct has an epoxidize ratio of 50-100%.

20. The self-emulsifying epoxy composition according to claim 16, wherein R¹, R², R³ and R⁴ are independently selected from C₁-C₁₀ aliphatic hydrocarbonyl groups and C₃-C₁₀ cycloaliphatic hydrocarbonyl groups.

21. The self-emulsifying epoxy composition according to claim 16, wherein the epoxide compound b) has a formula of III or IV 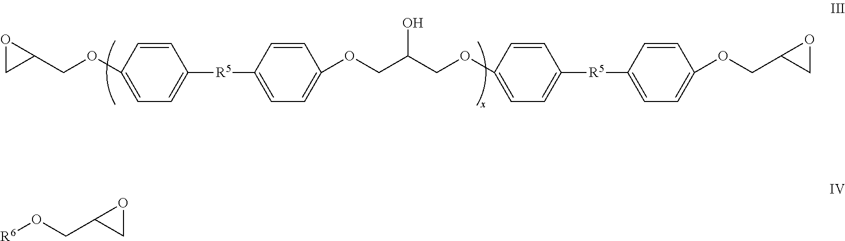
wherein x is 0 or an integer of 1 to 10, R⁵ is selected from aliphatic C₁-C₃₀ aliphatic hydrocarbonyl groups and C₃-C₃₀ cycloaliphatic hydrocarbonyl groups, R⁶ is selected from aliphatic, cycloaliphatic and aromatic hydrocarbonyl group having 3-20 carbon atoms.

22. The self-emulsifying epoxy composition according to claim 21, wherein R⁵ is a C₁-C₁₀ aliphatic hydrocarbonyl group.

23. The self-emulsifying epoxy composition according to claim 21, wherein R⁶ is selected from C₃-C₂₀ aliphatic hydrocarbonyl groups atoms and C₃-C₁₂ aromatic hydrocarbonyl groups.

24. The self-emulsifying epoxy composition according to claim 16, wherein the composition further comprises a bisphenol compound with an amount of 1-25 wt. %, based on 100% by weight of the self-emulsifying epoxy composition.

25. The self-emulsifying epoxy composition according to claim 24, wherein the bisphenol compound is selected from Bisphenol A, Bisphenol F and a combination thereof.

26. The self-emulsifying epoxy composition according to claim 16, wherein the solid in the self-emulsifying epoxy composition has a particle size diameter range with a D₉₀ from 0.3 μm to 3 μm, as determined by means of laser light diffraction.

27. A method for using the self-emulsifying epoxy composition according to claim 16, the method comprising using the self-emulsifying epoxy composition in coating, adhesive, sealant, and paints.

28. A coating composition comprising
a) an coating component comprising the self-emulsifying epoxy composition according to claim 16;
b) an epoxy curing agent; and
c) optional solvents and additives.

29. The coating composition according to claim 28, wherein the coating component has an amount of 40-70 wt. %, based on 100% by weight of the coating composition.

30. The coating composition according to claim 28, wherein the coating composition is a container coating, machinery coating, marine coating, or wind power coating.
